(19) United States
(12) Patent Application Publication
(10) Pub. No.: US 2017/0372170 A1
(43) Pub. Date: Dec. 28, 2017

(54) NETWORK-BASED CONTENT SUBMISSION AND CONTEST MANAGEMENT

(71) Applicants: David Young, Bellevue, WA (US); Aaron Linne, Bellevue, WA (US); Doug de la Torre, Bellevue, WA (US)

(72) Inventors: David Young, Bellevue, WA (US); Aaron Linne, Bellevue, WA (US); Doug de la Torre, Bellevue, WA (US)

(73) Assignee: Judgemyfoto Inc., Bellevue, WA (US)

(21) Appl. No.: 15/635,102

(22) Filed: Jun. 27, 2017

Related U.S. Application Data
(60) Provisional application No. 62/354,975, filed on Jun. 27, 2016.

(51) Int. Cl. G06K 9/62; G06K 9/46

(52) U.S. Cl. CPC G06K 9/623; G06K 9/4652

(57) ABSTRACT

In one aspect, the present disclosure implements a method of ranking images in real-time as the images are being received. In this regard, the method comprises receiving a first and a second images from end users. Then, the first and second images are made available to two or more human annotators from network accessible computing devices. The method provided by the present disclosure then receives designations from each of the two or more human annotators regarding whether the first or second image is preferred. From the received input, a determination is made, in the aggregate, whether the two or more human annotators preferred the first or second image. If the two or more human annotators preferred the first image, the method allocates a rank to the first image that is higher than the second image. On the other hand, if the two or more human annotators preferred the second image, the method allocates a rank to the second image that is higher than the first image.

### CROSS-REFERENCE TO RELATED APPLICATION

This application claims the benefit of U.S. Provisional Application No. 62354975, entitled “NETWORK-BASED CONTENT SUBMISSION AND CONTEST MANAGEMENT” filed Jun. 27, 2016, which is hereby incorporated by reference.

### BACKGROUND

The world is becoming increasingly multimedia-rich, where the ubiquity of camera-phones and digital cameras, combined with increasingly popular photo-sharing websites (e.g. Flickr, Photo-bucket, Picasa) and online social networks (e.g. Facebook, Instagram, Twitter) result in billions of consumer photographs available over the Internet, as well as in personal photo repositories. With this growth in the creation and sharing of digital images comes opportunities for various entities to better-engage a user base. One way to engage a user base is to sponsor a contest where submitted images are judged relative to each other with the best submissions being recognized or rewarded in some manner. Photo contests have traditionally required users to submit paper copies of images for judging. More recently, digital images have been submitted and judged using electronic mail or other network transmission technology. However, managing a photo contest is time-intensive and potentially cost-prohibitive especially when a large number of photos are submitted and need to be judged.

It is easy to recognize that the quantity of digital images and other media has grown exponentially with computers and especially the proliferation of mobile devises. However, the ability to identify the quality or aesthetic value of images and the selection of images that would be rated as aesthetically appealing has lagged behind the growth in multi-rich content. In the world of photography, the term aesthetics refers to the concept of appreciation and judgement of beauty and taste in photographic images, which is generally a subjective measure, highly dependent on image content and personal preferences. There is not universally agreed upon objective measures of aesthetics. Hence, the problem of image aesthetic assessment is an extremely challenging task. A number of efforts have been made in processing images using computers to automatically identify those images that are aesthetically pleasing. These efforts have met with a limited amount of success as identifying the “best” images or images that satisfy a criteria has proven difficult.

It would be beneficial to have a system that makes it easy and convenient to manage a contest utilizing network technologies to share data between the relevant participants. Preferably, the system would enable images to be judged in a way that is easy and convenient for both the user base and the contest sponsor.

### SUMMARY

This Summary is provided to introduce a selection of concepts in a simplified form that are further described below in the Description. This Summary is not intended to identify key features or essential features of the claimed subject matter, nor is the Summary to be used as an aid in determining the scope of the claimed subject matter.

In one aspect, the present disclosure implements a method of ranking images in real-time as the images are being received. In this regard, the method comprises receiving a first and a second images from end users. Then, the first and second images are made available to two or more human annotators from network accessible computing devices. The method provided by the present disclosure then receives designations from each of the two or more human annotators regarding whether the first or second image is preferred. From the received input, a determination is made, in the aggregate, whether the two or more human annotators preferred the first or second image. If the two or more human annotators preferred the first image, the method allocates a rank to the first image that is higher than the second image. On the other hand, if the two or more human annotators preferred the second image, the method allocates a rank to the second image that is higher than the first image.

### DESCRIPTION OF THE DRAWINGS

The foregoing aspects and many of the attendant advantages will become more readily appreciated as the same become better understood by reference to the following detailed description, when taken in conjunction with the accompanying drawings, wherein:

FIG. 1 is a block diagram depicting an exemplary cloud computing environment where described embodiments of the disclosed subject matter can be implemented;

FIG. 2 is a block diagram illustrating the components of a computing device configured to perform functions in accordance with the present disclosure;

FIG. 3 is a pictorial depiction of an exemplary flow diagram configured to add a submitted image to a contest in accordance with the present disclosure;

FIG. 4 is a pictorial depiction of an exemplary flow diagram operable to rank a submitted image in accordance with the present disclosure;

FIG. 5 is a pictorial depiction of an exemplary user interface operable to convey force ranking information to a user in accordance with the present disclosure; and

FIG. 6 is a pictorial depiction of an exemplary flow diagram for identifying a preferred image given data generated by the system in accordance with the present disclosure.

### DESCRIPTION

The description set forth below is intended as a description of various embodiments of the disclosed subject matter and is not intended to represent the only embodiments. Each embodiment described herein is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In one aspect, the present disclosure implements an application capable of being executed by computing devices such as a mobile phones, tablets, laptop computers, desktops, server computers, and the like. In various embodiments, the application enables users to submit user-generated content, such as photos, to one or more online contests that are judged relative to other submissions or criteria. The user-generated content may be accepted or rejected upon submission using pre-processing tools which may also serve to decrease the total set of pictures being available for human judging. These pre-processing tools provided by the present disclosure can ensure compatibility with the contest requirements before completion of a submission. Also, the pre-processing tools may measure certain attributes of a submitted photo as described in further detail below. Systems are provided to enable humans, which may include experts, participants, sponsors, employees, friends or any other group to critique and judge submitted photos using various criteria. In some embodiments, submitted images are judged against the submissions of other entrants thereby identifying a ranking among a plurality of submissions. In this way, the present disclosure facilitates the management of a contest to rank, analyze, and tag the user-submitted content. While the description provided herein is primarily made in the context of user-submitted images, the submissions may be other types of user-generated content without departing from the scope of the claimed subject matter.

In additional aspects, the present disclosure provides a marketplace for the submission and sale of user-generated content such as images. Artists are able to submit images for sale within the marketplace. Once offered for sale, users may browse and access various types of images that have been made available for purchase. In this regard, images may be accessed according to one or more display categories such as whether an image is a contest winner, content type, or other criteria. As described in further detail below, aspects of the present invention also performs pre-processing to identify particular content (people, places, and things) that is depicted in submitted images. This content as well as descriptors provided by users or machine vision systems may be associated with submitted images as, for example, meta data. As a result of this processing, searches may be performed and images may be accessed according to the content or descriptors represented in their associated meta data. For identified images, the marketplace enables user to acquire image rights and gain access to purchased images.

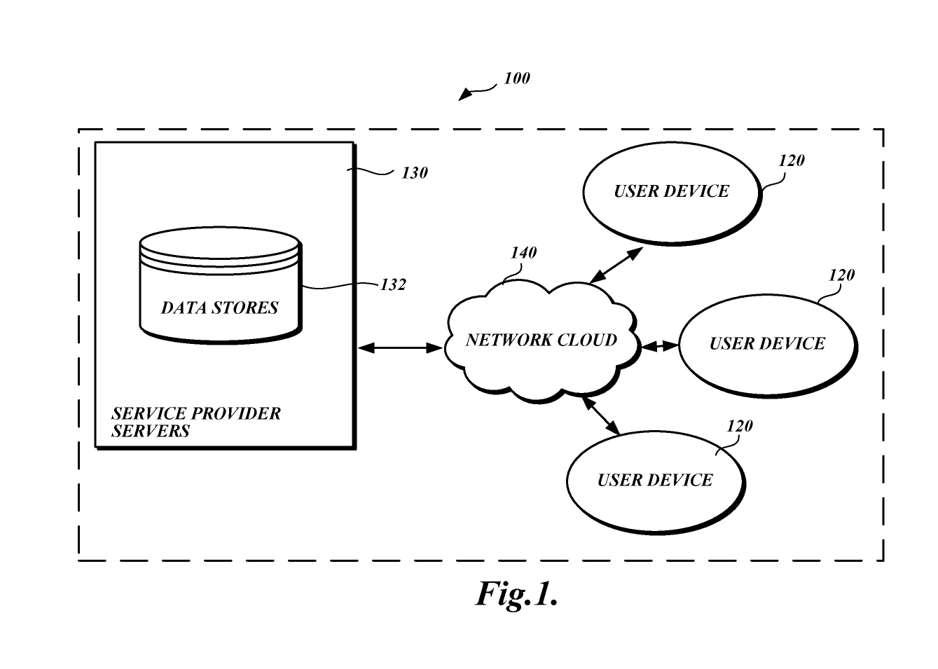

Referring now to FIG. 1, the following is intended to provide a general overview of a system environment 100 where embodiments of the disclosed subject matter may be implemented. The illustrative system environment 100 depicted in FIG. 1 includes one or more user devices, such as user device(s) 120, configured to communicate with other user devices or with the service provider server(s) 130 via a network cloud 140. The user device 120 may be any one of a number computing devices such as, but not limited to, mobile phones, laptop or tablet computers, personal digital assistants (PDAs), desktops, media players, game consoles, home messaging base stations and routers, or any other device configured to perform communications via the network cloud 140.

As shown in FIG. 1, the user device 120 can communicate with the service provider server 130 via the network cloud 140. In some embodiments, the service provider server 130 may include one or more data store(s) 132. The data store 132 may store various types of information such as but not limited to user behavior history, user profile information (e.g., user account information), billing information, knowledge base, etc. In an illustrative embodiment, the data store 132 may also contain transaction data relative to users. This transaction data may include, but is not limited to transaction type (purchase, award, etc.), actual cost, actual revenue, date of transaction, and geolocation of transaction. While the data stores 132 in FIG. 1 are shown as being associated with the service provider server 130, one skilled in the art will recognize that other implementations are possible. Increasingly, data storage and database services are available as cloud services. Accordingly, in other embodiments, the data stores 132 may be available as a cloud service without departing from the scope of the claimed subject matter.

It should be well understood that the user devices 120 are not required to have a dedicated network connection in order to submit images or participate in a contest. In this regard, the application provided by the present disclosure may be configured to principally execute locally on the client computing device. Various types of user data and actions may be cached on a client computing device but can persist to the service provider server 130 once a network connection is re-established. Accordingly, communications between the user devices 120 and the server-side data center 102 may be intermittent and optimized for a particular type of network such as a containerized network on-board a cruise ship, commercial airline, and the like.

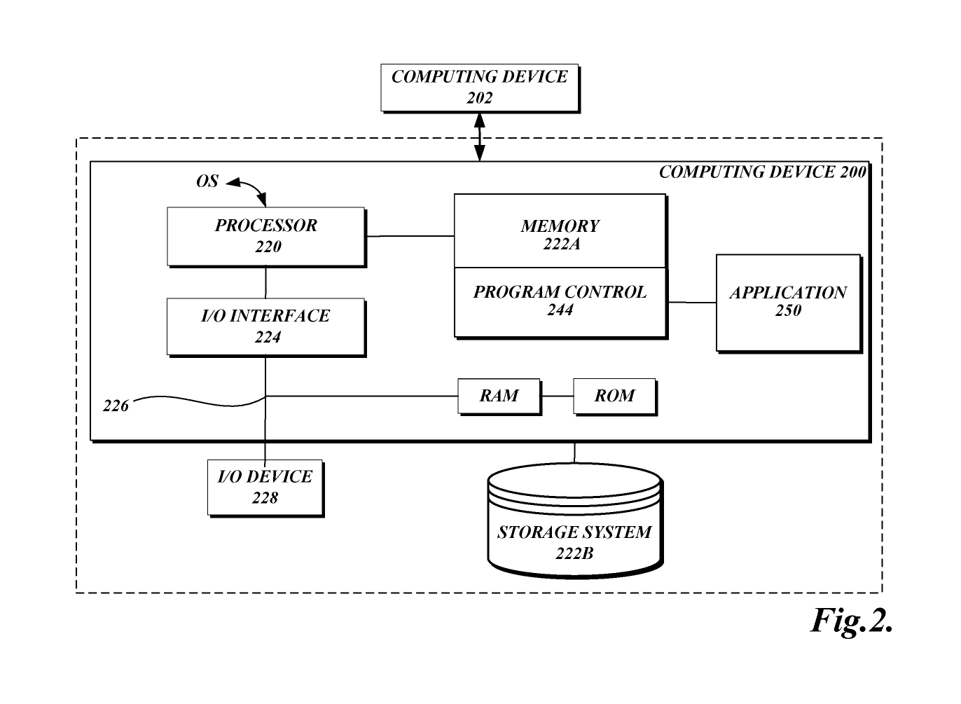

Now with reference to FIG. 2, additional description will be provided regarding the server provider servers 130 (FIG. 1) and user devices 120 (FIG. 1). In embodiments, the user devices 120 can be mobile devices (smart phones and tablets), desktop computers, or any other similar device capable of executing an “app” provided by the present disclosure or a Web browser. The servers 130 can be a standalone server, which implements the processes of the present invention within a networking environment. In this regard, the architecture of the servers 130 or user devices is depicted in FIG. 2 in the computing device 200 which can be resident on a network infrastructure. As shown, the computing device 200 includes a processor 220 (e.g., a CPU), a memory 222A, an I/O interface 224, and a bus 226. The bus 226 provides a communications link between each of the components in the computing device 200. In addition, the computing device 200 includes a random access memory (RAM), a read-only memory (ROM), and an operating system (O/S). The computing device 200 is in communication with the external I/O device 228 and a storage system 222B. The I/O device 228 can comprise any device that enables an individual to interact with the computing device 200 (e.g., user interface) or any device that enables the computing device 200 to communicate with one or more other computing devices (e.g., user devices 120) using any type of communications link.

The processor 220 executes computer program code (e.g., program control 244), which can be stored in the memory 222A and/or storage system 222B. In embodiments, the program control 244 of the computing device 200 provides an application 250, which comprises program code that is adapted to perform one or more of the processes described herein. The application 250 can be implemented as one or more program code in the program control 244 stored in memory 222A as separate or combined modules. Additionally, the application 250 may be implemented as separate dedicated processors or a single or several processors to provide the functions described herein. While executing the computer program code, the processor 220 can read and/or write data to/from memory 222A, storage system 222B, and/or I/O interface 224. In this manner, the program code executes the processes of the present disclosure.

The program code can include computer program instructions that are stored in a computer-readable storage medium. The computer program instructions may also be loaded onto a computer, other programmable data processing apparatus, or other devices to cause a series of operational steps to be performed on the computing device. Moreover, any methods provided herein in the form of flowcharts, block diagrams or otherwise may be implemented using the computer program instructions, implemented on the computer-readable storage medium. The computer-readable storage medium comprises any non-transitory medium per se, for example, such as electronic, magnetic, optical, electromagnetic, infrared, and/or semiconductor system. More specific examples (a non-exhaustive list) of the computer-readable storage medium include: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any combination thereof. Accordingly, the computer-readable storage medium may be any tangible medium that can contain or store a program for use by or in connection with an instruction execution system, apparatus, or device of the present invention.

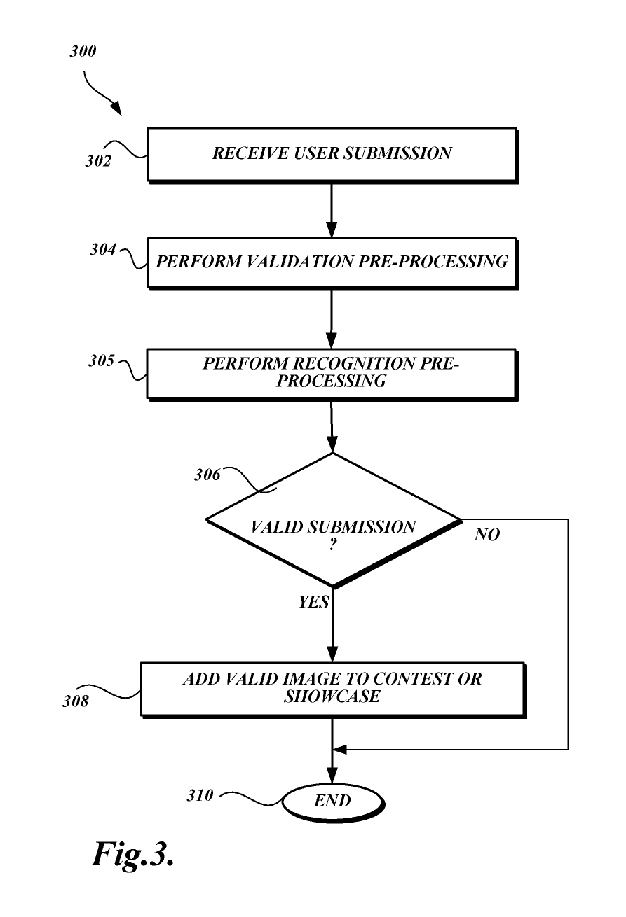

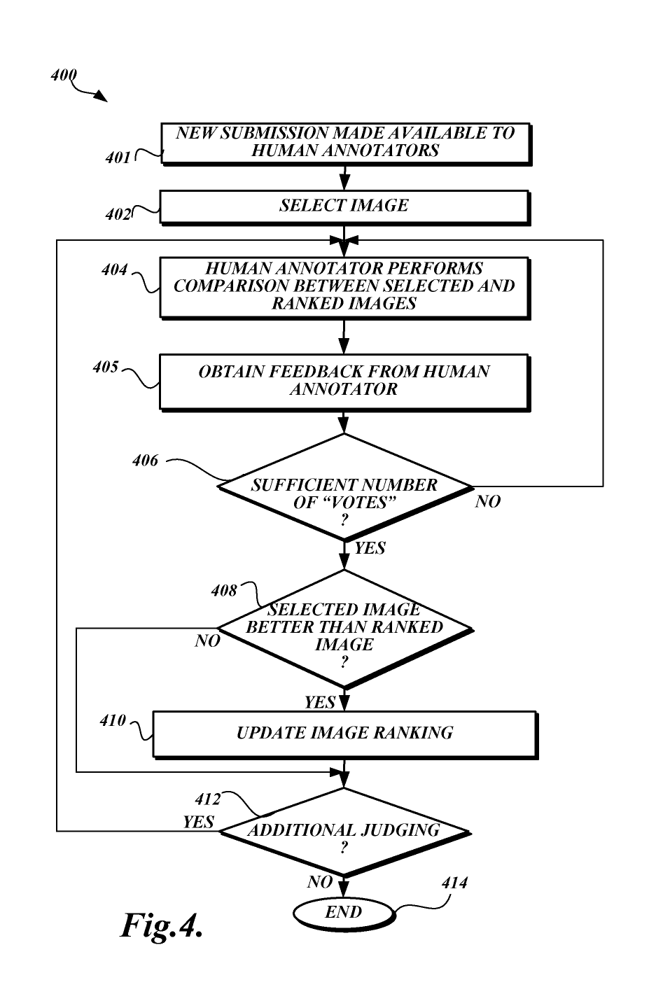

Now with reference to FIG. 3 a contest management method 300 operable to manage a network-based contest in accordance with the present invention will be described. In general, the contest management method 300 is responsible for accepting user submissions to a contest and ranking the received submissions. Each user submission is processed to insure that the submission meets certain specified criteria. If the specified criteria are satisfied, than a submission is accepted for entry into the contest. Once a sufficient number of submissions are received, a force ranking process (FIG. 4) is undertaken to compare user submissions accordingly. The force ranking process may be used to identify a contest winner and/or determine whether submitted images best satisfy a specified criteria as described in further detail below.

As illustrated in FIG. 3, the contest management method 300 begins at step 302 where a user submission is received. In one aspect, the present disclosure provides an application operating on an end-user's computing device (such as the user device 120 illustrated and depicted in FIG. 1). The application is configured with an interface that enables users with the ability to interact with information resources provided by the present invention. For example, through a set of requests/response interactions with an application or web interface provided by the present disclosure, a privileged user may create a new photo contest or showcase. Once the contest or showcase has been created, an end user may select a button or other user interface control in order to enter the contest and upload an image. At step 302, an end user provides an input event to submit an image and compete in a contest.

At step 304 of the contest management method 300 validation pre-processing of a received user submission is performed. As mentioned previously, aspects of the present disclosure enable a user to upload an image for entry into, for example, a photo contest. When a user submits an image, validation pre-processing is performed to ensure compatibility with the contest before acceptance of the entry. In one aspect, this pre-processing includes technical testing of the received image from which a binary positive or negative result can be derived. In this regard, the battery of tests performed at step 304 may include, but is not limited to, processing the received file to determine whether the file is corrupted, scanning the file for malware, determining whether the file contains valid RGB (Red, Green, Blue) values, determining whether the file is an image by confirming that it includes pixel values indicative of multiple colors, comparing the file to a database such as Google images or similar online repository.

In addition to the validation pre-processing, the contest management method 300 also performs recognition pre-processing at step 305. The recognition pre-processing performed at step 305 includes analyzing images in a number of other of ways. For example, the received file is analyzed to identify the technical attributes (color usage, focus, lighting, sharpness, contrast, etc.) of the image. Moreover, the recognition pre-processing performed at step 305 includes applying machine visions systems to identify image content that is typically comprised of “people, places, and things.” The identified image content is used in a number of different ways by aspects of the present invention as will be made clearer in the description below. In this regard, contest sponsors may define rules for contest entry that prohibit nudity, brand promotion, and the like. The recognition pre-processing performed, at step 305, includes processing and analyzing image content to insure compliance with the content rules. Specifically, a submission may not include content that is prohibited by the content rules and submissions are rejected that violate those rules.

The pre-processing performed, at steps 304-305, is used to determine whether a received entry is a valid image having attributes that satisfy contest requirements or rules. Accordingly, at decision step 306, a determination is made whether a received entry has satisfied the requirements to be a valid entry into a contest or showcase. In the event a “NO” determination is made, at step 306, then the user may be provided with feedback that identifies the one or more requirements that was not satisfied. In some instances, the user interface provided by the present disclosure enables the user to correct an identified problem and subsequently upload a valid submission. Then, the contest management method 300 proceed to step 310, where it terminates.

In the event the result of the test performed at step 306 is “YES”, the contest management method 300 proceeds to step 308. Then, processing is performed, at step 308 to add a valid submission to a previously created contest or showcase. As described in further detail below, submissions to a contest may be displayed or otherwise made available from a network-based user interface provided by the present disclosure. In this regard, submitted images may be accessed and viewed by others as will become clearer from the description that follows. Then, the contest management method 300 proceeds to step 310, where it terminates.

### Usage of Human Annotators for Force Ranking a Contest

In some aspects of the present disclosure, systems and/or methods are provided to perform efficient human-originated scoring and ranking of incoming submissions received from multiple sources, and to do these annotations at substantially the same time as submissions are received in a contest or showcase. In this regard, the systems provided by the present disclosure include multiple clients in communication with a server that provides functionality for scoring and ranking images in a way that is accessible by the multiple clients. The incoming submissions may be processed in various ways and routed to the appropriate human-annotators. In turn, the subsequent computer-based scoring and ranking of images is submitted back to the system provided by the present disclosure. In this regard, the routing process enables images and associated data to be remotely distributed from the remotely located clients to the server. As such, the present disclosure provides a distribution service that enables scoring, ranking, and tagging from multiple client annotators within a client/server architecture. In some embodiments, the rankings are constantly updated as new entrants are received by the system. As such, the scoring and ranking of images is typically performed throughout and during the course of the contest, not once all the submissions have been received, due to the potential lag in human processing.

Now with reference to FIG. 4 a force ranking method 400 configured to cause images to be ranked by human annotators in accordance with the present invention will be described. In general, aspects of the force ranking method 400 enables submissions to be ranked against other entrants by humans interacting with the application (hereinafter “human annotators”) provided by the present disclosure. In exemplary embodiments, the ranking is performed on a one-to-one or one-to-many basis by human annotators who directly compare images submitted to the contest. In general, the force ranking method 400 may first identify a general ranking of a submission (i.e. 50^{th} percentile), then additional comparisons may be performed to identify a more specific ranking. For example, a first one-to-one comparison of an image may be relative to an image that was previously ranked at the 50^{th} percentile from all of the received images. If a determination is made that a submission is better than the 50^{th} percentile image, then a comparison may be performed with a different image previously ranked at the 25th percentile. These comparisons may continue to be performed until a sufficiently accurate ranking is identified for a specific image.

As illustrated in FIG. 4, the force ranking method 400 begins at step 401 where a new submission is made available to human annotators for judging relative to other submissions. In some embodiments, human annotators are identified and selected to participate in tagging and ranking images because they are contest sponsors, employees, friends, subject matter experts, or a member of another type of group. In other instances, human annotators are potentially random humans so that the tagging and ranking of images as described herein is effectively “crowd-sourced.” Significantly, the present disclosure provides the infrastructure and workflow for assigning tasks to the pool of human annotators. This infrastructure enables explicit ranking and tagging of images to be performed without users needing to have any skill in photography. In this regard, a subset of properly credentialed human annotators may be provided with access to a Web or network-based user interface provided by the present disclosure in order to undertake their judging duties. In judging the contest, a human annotator will typically login at the user interface and access a judging screen associated with a specified contest. Submissions to the contest are typically analyzed by multiple judges that make up a judging pool. The client/server architecture described with reference to FIG. 1 above and the application provided by the present disclosure enables the judging pool to access and analyze images from potentially anywhere. Ranking and tagging information may be communicated between the user and the service provider servers 130 from any number of different client computing devices as described above with reference to FIG. 1.

At step 402 of the method 400, a submitted image is selected for ranking in an exemplary embodiment of the present disclosure. Then, at step 404 of the exemplary force ranking method 400 depicted in FIG. 4, a human annotator performs a comparison between the image selected, at step 402, and a previously ranked image. In this example, image rankings may be performed on a one-to-one basis with a first submission being compared to a second submission by the human annotator. As mentioned previously, the selected image can be compared to an image, that has a known ranking (i.e. 50^{th} percentile). In other words, the human annotator effectively “votes” to identify which of the two images being compared, at step 404, is better given the purpose of the contest.

At step 405 of the method 400, feedback may be obtained from the human annotator regarding the reasoning behind their selection of a particular image. In the process of “voting” for an image, the human annotator may be presented with a list of reasons for their selection of one image over another. These reasons or “qualifiers” enable human annotators to choose and potentially associate certain descriptors with a particular image. By way of example, qualifiers that uniquely identify why a human annotator prefers one image over another can include such adjectives as sexy, romance, techie, adrenaline, and the like. One skilled in the art and others will recognize that images may be described in a number of different ways and the examples provided herein should be construed as exemplary. When a significant number of human annotators selects a common qualifier for a particular image, the image file may be “tagged” with that qualifier which is typically represented as file metadata by the present disclosure.

At decision step 406, a determination is made regarding whether the selected image has received a sufficient threshold number of “votes.” To insure statistical significance of the data being generated by the human annotators, the force ranking method 400 may require that a data set of sufficient size has been generated. In some instances, a significant data set may be generated as a result of a sufficiently large pool of human annotators reviewing the image. In addition or alternatively, a significant data set may be generated as a result of multiple rounds of “voting” even if the pool of human annotators used to analyze an image is relatively small. In any event, a certain number of human annotators should have “voted” for the selected image before assigning the selected image a new ranking. This insures that image rankings accurately reflects the opinions of the human annotators in the aggregate. If the result of the test performed at step 406 is “YES” then the force ranking method 400 proceeds to step 408, described in further detail below. On the other hand, if the result of the test performed at step 408 is “NO” then the force ranking method 400 proceeds back to step 404, and steps 404-406 repeat until a sufficient data set has been generated. In other words, additional human annotators are provided with the opportunity to analyze the selected image until a sufficiently large data set is generated.

At steps 404-406 above, a process is described for performing potentially multiple one-to-one comparisons to narrow in and specifically identify a selected image's ranking. In this exemplary embodiment of the present invention, multiple comparisons may need to be iteratively performed to achieve a sufficiently accurate result. In an alternative embodiment, image rankings are performed on a one-to-many basis where a human annotator may be presented with multiple images for comparison at once. In this instance, the human annotator may be prompted to perform a comparison in which a “best” image from a plurality of images is identified. In addition or alternatively, the human annotator may be prompted to generate an ordering of all of the presented images from best to worst. In either instance, the human annotator performs a one-to-many comparison in ranking a submitted image which may be useful for a number of different reasons. By way of example, one benefit of a one-to-many comparison is that the system may generate a substantial data set in a single pass. As a result, data can be generated in a way that enables the system to arrive at a rough result very efficiently and quickly.

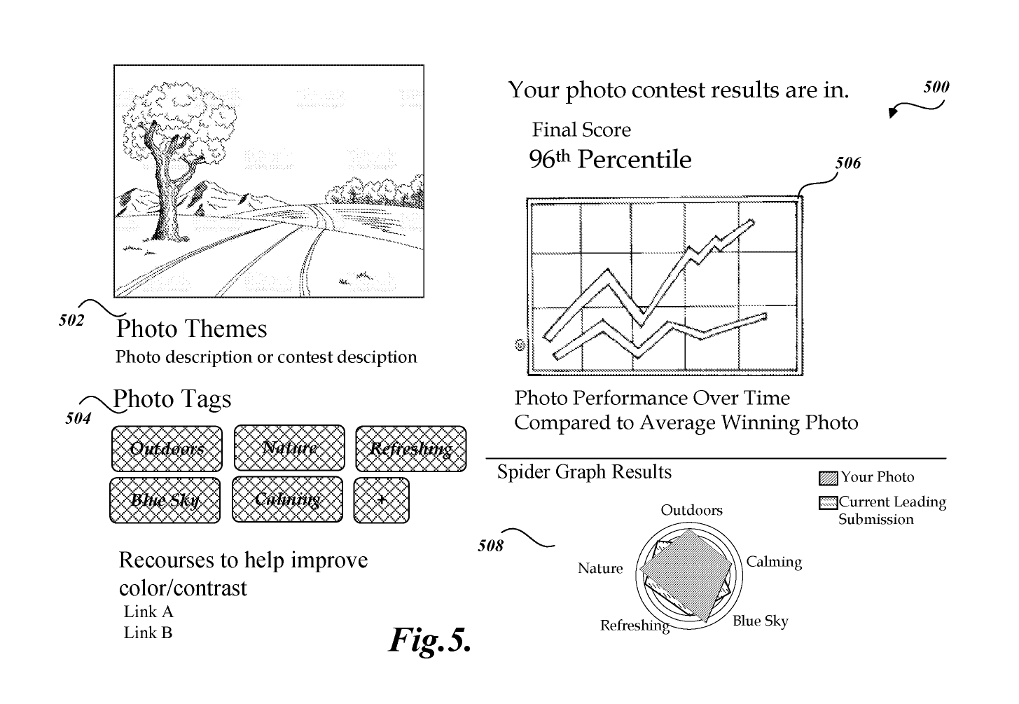

Once an image has received a sufficient number of “votes”, the force ranking method 400 proceeds to decision step 408 where a determination is made regarding whether the image selected at step 402 should be ranked at a higher position than the one or more images that it was compared against. In completing the comparisons described above, the human annotator effectively votes for or against a selected image. The processing performed at step 408 identifies a best image between the two or more images using all of the data generated by the human annotators. In the example of a one-to-one comparison, if more than 50% of the human annotators indicate that the image selected at step 402 is better between the two images, then the result of the test performed at step 408 is “YES” and the force ranking method 400 proceeds to step 410 described in further detail below. On the other hand, if the human annotators indicate that the image selected at step 402 is not the better of the two images, then the force ranking method 400 proceed to step 412 also described in further detail below. In other embodiments, identifying image ranking may be performed by generating a multi-dimensional score. In this instance, an image is allocated n dimensions of ‘scores’ with each of the different dimensions being associated with a qualifier. These qualifiers would be substantially similar to those described with reference to the “PHOTO TAGS” area 504 in FIG. 5 below. An evaluation can then be performed that weights each of the n score dimensions so that an image may be evaluated across certain defined qualifiers to determine rankings.

At step 410, the ranking of the image selected at step 402 is updated to reflect the input received from the human annotators. If step 410 is reached, the ranking of an image within the system needs to be updated to reflect the input received from the human annotators. In this regard, the actions undertaken at step 410 includes updating the ranking of a submission within the contest to reflect the voting undertaken by the human annotators. An exemplary user interface that identifies a submission's ranking in a contest will be provided below in the description that is made with reference to FIG. 5.

At decision step 412, a determination is made as to whether additional judging of the image selected at step 402 should be performed. As mentioned previously, the force ranking method 400 may identify a general ranking of a submission (i.e. 50^{th} percentile), than additional comparisons may be performed to identify a more specific ranking. For example, a first one-to-one comparison of an image may be performed relative to an image that was previously ranked at the 50^{th} percentile from all of the received images. If a determination is made that a selected image is better than the 50^{th} percentile image, then additional comparisons may be performed. In this regard, the selected mage may then be compared to an image previously ranked at the 25th percentile. These comparisons may continue to be performed until a sufficiently accurate ranking is identified for a specific image. Similarly, a one-to-many comparison may be performed with a selected image being compared relative to images previously ranked at different percentiles. These comparisons may also continue to be performed using the pool of human annotators until a sufficiently accurate ranking is identified for a specific image. In these instances when the result of the test performed at step 412 is “YES” and additional judging may be performed, the method 400 proceeds back to step 404 and steps 404-412 repeat until a sufficiently accurate ranking is identified.

There are a number of instances in which aspects of the present disclosure will determine that judging of a particular image in the contest should cease. In some instances, additional comparisons may not need to be performed as determining that the submitted image is worse than the 50^{th} percentile image may be sufficient to decide, for example, that the submitted image will not be a contest winner. In this regard, a number of optimizations may be implemented to minimize the effort that needs to be expended by the human annotators or others in managing the contest. Moreover, aspects of the present disclosure may provide compensation or other reward to the human annotators in judging the contest. In instances when the rewards provided to the human annotators is scarce or otherwise needs to be preserved, the system may determine that judging activities needs to cease or be minimized given the ranking of an image. In instances when the system determines that additional judging is not necessary, the result of the test performed at step 412 is “NO” and the force ranking method 400 proceeds to step 414 where it terminates.

It should be well understood that the methods described above with reference to FIGS. 3-4 do not show all of the functions performed within the computing environment 100 depicted in FIG. 1. Instead, those skilled in the art and others will recognize that some functions or steps described above may be performed in a different order, omitted/added, or otherwise varied without departing from the scope of the claimed subject matter. For example, FIG. 4 above describes a process in which human annotators are utilized in analyzing, ranking, and tagging images. In other embodiments of the present disclosure, artificial intelligence systems are utilized to perform the same or substantially similar steps as those described in FIG. 4. In these instances, data sets that describe image attributes may initially be generated by human annotators. From this data, the importance of variables and relationship dependencies in recognizing certain image attributes can be identified and used to generate an artificial intelligence (“AI”) model. With a defined model for processing and identifying attributes in images, the AI system can begin performing some or all the tasks previously performed by the human annotators.

### Revenue-Controlled Force Ranking Process

As mentioned previously above, a number of optimizations may be implemented to manage costs and minimize the effort that needs to be expended by the human annotators. The system provided by the present disclosure may have various revenue sources and costs associated with the submission and ranking of images as described above with reference to FIG. 4. For example, human annotators may be compensated to score and rank images. When a collection of items is submitted for a forced ranking analysis, aspects of the present disclosure provides functionality to control financial variables related to the forced ranking process. More generally, the present disclosure is concerned with two primary variables: profit and costs. Functionality is provided to adjust the intended profit per entry dynamically for each contest. In this regard, the expense variable optionally consists of a number of factors including transaction expense, donation expense, technical expense, and processing expense. In the expense category, the processing expense is heavily monitored in conjunction with the actual ranking of submissions. Depending on a configurable variable, submissions may cease to have new judgements placed on their ranking. In so doing, the present disclosure conserves resources and money spent for submissions that are clearly not able to win the contest. Instead, funding is conserved for analyzing and scoring high-ranking submissions.

Now with reference to FIG. 5, one exemplary graphical user interface is shown with user interface elements suitable for illustrating various aspects of the present disclosure. In the exemplary embodiment depicted in FIG. 5, an image ranking screen 500 is displayed that includes a “PHOTO THEMES” area 502, the “PHOTO TAGS” area 504, the Line Graph Area 506, and the Spider Graph Area 508. In general, the user interface elements utilized by the present application such as those depicted in FIG. 5 provide convenient ways of interacting with and providing information to the user. In addition, controls are provided that enables the system to obtain input and generate robust information-packed meta data that can be used for artificial intelligence and marketing purposes.

As mentioned previously, systems and/or methods are provided to perform efficient human-enhanced ranking and tagging of incoming submissions received from multiple sources, and to do these annotations at substantially the same time as submissions are received. In this regard, the scoring and ranking of images can be accessed by appropriate users. From the user interface provided by the present disclosure, users can track their performance in a contest or showcase. As shown in FIG. 5, a user that entered a submission in a contest can follow the ranking of the photo, on an on-going basis. In this regard, information is provided on the ranking screen 500 in the Line Graph Area 506 which, in this example, compares the submission's ranking over time to an average winning photo. In other examples, a user's submission may be compared to other types of images such as the highest scoring image to date, the historically best photo, average top ten photo, a user's best or most recent image etc., and combinations thereof. Significantly, the present application implements a workflow of ranking, analysis, and tagging of images that is performed in real-time so that this and other types of robust data may be generated on demand.

As described previously with reference to FIGS. 3-4, robust meta data that describes a submitted image may be generated and used in various ways by aspects of the present disclosure. In some instances, the meta data is generated by machine visions systems which analyze an image to identify image content that is typically comprised of people, places, and things (see step 305 of FIG. 3). In other instances, the meta data is generated by human annotators or AI systems which reflect human (or modeled) perceptions of an image. These qualifiers can be virtually anything that is suitable for describing an image. In the example, depicted in FIG. 5, the “PHOTO TAGS” area 504 presents a plurality of qualifiers that have been associated with the displayed image. In this example, the qualifiers include the terms “Outdoors,” “Nature,” “Refreshing,” “Blue Sky,” and “Calming.” One skilled in the art and others will recognize that images may be described in a number of different ways and the examples provided herein should be construed as exemplary. Significantly, the qualifiers implemented by the present disclosure extend beyond just image qualities and can be virtually anything including, but not limited to, emotional assessments (relaxing, calming), adjectives (hot, fast, sexy), nouns (sunshine, outdoor, nature), verbs (refreshing, motivational,), etc.. Moreover, qualifiers are configurable so that sponsors or others can define contests in which images having specific defined qualities can be identified and rewarded. In this regard, human annotators or artificial intelligence systems may be prompted to judge a competition with regard to how well a submitted image matches a particular qualifier. Accordingly, the present disclosure enables new types of competitions to be conducted in which images that best match a particular quality of interest are identified. One skilled in the art and others will recognize that other information may be provided to the user or displayed and feedback obtained in different ways than shown in FIG. 5 without departing from the scope of the claimed subject matter.

### Meta-Data Enhanced Tokens for Contest Entry

In one aspect of the present disclosure, a user is able to obtain monetary credits for their account which may be used to make purchases in the marketplace. Each credit may have associated metadata which describes certain unique attributes. Instead of a simple record describing the quantity of credits or separate records for each transaction, a credit can exist as a unique object that is extensible. In this regard, the attributes of the credit object may include, but are not limited to, transaction type (purchase, award, etc.), actual cost, actual revenue, date of transaction, and geolocation of transaction, among others.

Typically, the credit metadata is not made available to the user, who is able to access a summary of the quantity of available credits and a history of transactions with credits. The metadata is used for both analytics regarding the purchase of credits but also for financial management of the system. By maintaining an analysis of the origins of credits, functionality is provided to track how much real money is in the marketplace economy against promotional credits. This analysis assists in managing the amount of money that may be made available to award winners and how much money has been spent on entering a contest instead of promotional credits.

### Variable Value Credits Related to a Revenue Generating Event

In additional embodiments of the present disclosure, the submission of an image to a contest is a revenue-generating event. When a revenue-generating event occurs and the user has credits with different financial values, their credits may be placed in a virtual escrow. In this regard, the user's credit values may be stored such that a future determination can be made to identify which credit value to use in completing the revenue-generating event. Aspects of the present disclosure may initially attempt to “spend” the credit with the least financial value (i.e. credits given away as promotions) while still achieving the expected profit generation for a particular contest. More generally, any combination of user credits that have different financial values may be used in a dynamic manner to complete the revenue-generating event and/or optimize profitability. In additional aspects of the present disclosure, the combination of users' credits that have different financial values are managed and adjusted if the user's variable credits need to be considered across multiple events that are happening concurrently.

### Managing the Flow of Expenses and Revenue

As expenses are incurred and bills received, aspects of the present disclosure may verify and accept a bill as a technical expense for a given period. Based upon the time frame for the expense, functionality is provided to anticipate the number of upcoming transactions in a configurable period and reserve funds from revenue-generating transactions. In this way, the present disclosure may manage the flow of funds in order to insure that the necessary money is available to pay off the technical expense at the appropriate period of time.

In addition to managing the payment of expenses, aspects of the present disclosure also manage the flow of revenue. For each revenue-generating event (or contest), desired profit and expense levels are identified as determined in the revenue-controlled force ranking process. At the end of the revenue-generating event, funds that were not actually spent may be maintained in an expense reserve. In this instance, the present disclosure may maintain funds separate from generated profit so that the funds are available for future processes in a way that insures consistent profit generation.

### Predictive Machine Learning

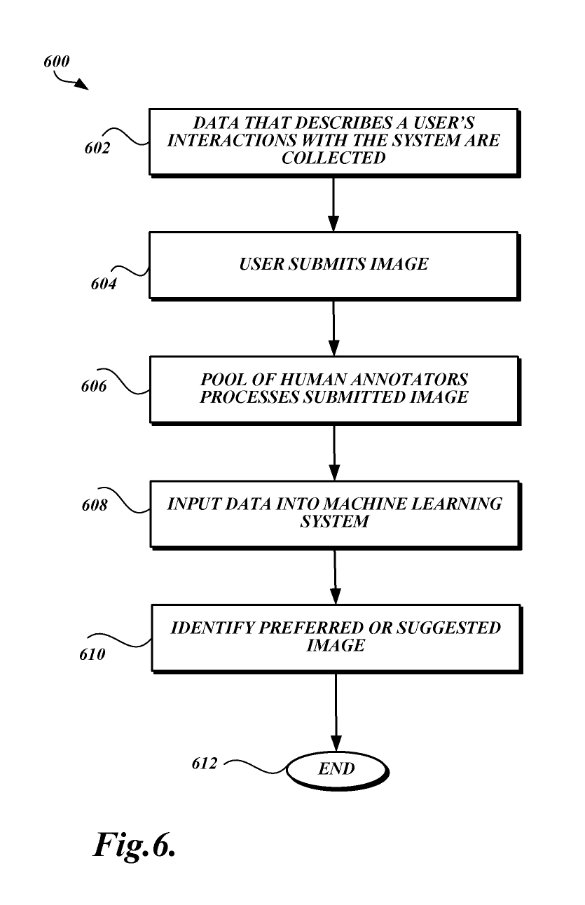

Now with reference to FIG. 6 a selection method 600 configured to identify preferred images for particular users in accordance with the present invention will be described. As illustrated in FIG. 6, the selection method 600 begins at step 602 where a set of data that describes a user's interactions with the system provided by the present disclosure is generated and collected. As mentioned previously, the present invention provides an application that may be installed on a user's device. Once installed, the application is able to access and collect a set of profile data about the user that may include, but is not limited to age, location, gender, etc. This and other types of data about the user may be identified using a cookie, and/or digital certificates. In addition, a user may provide profile data in a set up process when establishing an account with the application provided by the present invention. By interacting with the application provided by the present disclosure, the user generates additional types of data that gives insights into their tastes and preferences. For example, a user may upload images depicting particular subject matter for entry into one or more contests. These images are potentially analyzed in various ways and tagged accordingly. At least some of a user's interests and tastes may be derived from the image content that has been uploaded. In addition, a user interacts with the system provided by the present disclosure in a number of other ways. Users search for, access, and purchase rights to images having particular subject matter using keyword searches. In this regard, the user's interactions with the system provided by the present disclosure as described herein is continually tracked and memorialized. In these interactions, a robust set of data that reflects a user's attributes, tastes, and preferences is generated and collected, at step 602. It should be noted that the data is collected not only from end users but also from human annotators that process images in various ways.

Then, at step 604 of the selection method 600, an image is submitted to the application provided by the present disclosure. This aspect of the present invention in which users are able to submit images to a contest or showcase is described above with reference to FIG. 3 and will not be repeated here. However, it should be noted that once an image is submitted, pre-processing is performed to determine whether the image is a valid submission (steps 304-305 of the contest method 300 described above in FIG. 3). As part of the pre-processing steps, the present invention applies machine visions systems to identify image content that is typically comprised of “people, places, and things.” In one aspect, image content may be used to determine which images are preferred given what is known about a particular user.

At step 606 of the selection method 600, a pool of human annotators or AI system processes the image submitted at step 604. In the event of a contest, one way in which the human annotators process an image is described above with reference to FIG. 4. Specifically, the submitted image may undergo the force ranking method 400 in which human annotators may compare images relative to each other to identify a contest winner. Since this aspect of the present invention is described above with reference to FIG. 4, it will not be repeated here. However, as part of the process of force ranking images, human annotators may process the submitted image in ways that generates semantic context. As mentioned previously, human annotators may be presented with a list of reasons for a selection when comparing images during the force ranking process. By making these selections, the human annotators are able to choose and potentially associate certain descriptors with a particular image. In the “PHOTO TAGS” area 504 and Spider Graph Area 508 depicted in FIG. 5, exemplary descriptors that may be associated with an image by human annotators are provided.

At step 608 of the selection method 600, data that describes a set of images is input into a machine learning system. One skilled in the art will recognize that a machine learning system is one in which a computer system is not programmed to solve a desired task directly. Instead, the machine learning paradigm can be viewed as “programming by example” in which methods are implemented so that the computer system will adjust its own program based on provided examples. As images are analyzed in the various ways described herein, the generated data is fed into the machine learning system. This content and contextual data serves as the training set for the machine learning system. In turn, the machine learning system builds a model of preferred images that accounts for the attributes and preferences collected from users including the human annotators. From this data, the importance of variables and relationship dependencies in recognizing preferred images can be identified and used to define and refine the AI model.

At step 610 of the selection method 600, a preferred or suggested image is identified potentially using the identified preferences of one or more users. As mentioned above, a user's interactions with the system provided by the present disclosure is continually tracked and memorialized. From these interactions a robust set of data that reflects users attributes, tastes, and preferences is known. With this information, the system is able to determine which images are preferred, not generically, but based on data generated from users interactions with the system. Specifically, the AI model built at step 608 of the selection method 600 can identify images which possess the descriptors or other semantic data that has been identified as being preferred. These preferred images may be further filtered to account for what is known about a specific user or group. For example, content identified as being in an image (animals, people, art, food, etc.) may be used to determine which images are preferred given how a user or group has interacted with the system. More generally, the system generates a vast amount of data that describes aspects of each submitted image. To identify images that are the most relevant, this data may or may not be filtered relative to a particular user's identified range of tastes and preferences. Then, the selection method 600 proceeds to step 612, where it terminates.

It should be well understood that the methods described above with reference to FIG. 6 do not show all of the functions performed within the computing environment 100 depicted in FIG. 1. Instead, those skilled in the art and others will recognize that some functions or steps described above may be performed in a different order, omitted/added, or otherwise varied without departing from the scope of the claimed subject matter.

While the preferred embodiments of the present disclosure have been illustrated and described, it will be appreciated that various changes can be made therein without departing from the spirit and scope of the disclosed subject matter.

1. A method of ranking images in real-time as the images are being received, the method comprising:
receiving a first and a second image;
in a computer networking environment, making the first and second images available to two or more human annotators;
receiving designations from the two or more human annotators regarding whether the first or second image is preferred;
determining, in the aggregate, whether the two or more human annotators preferred the first or second image;
if the two or more human annotators preferred the first image, allocating a rank to the first image that is higher than the second image; and
if the two or more human annotators preferred the second image, allocating a rank to the second image that is higher than the first image.
